(19) United States
(12) Patent Application Publication
(10) Pub. No.: US 2013/0112157 A1
(43) Pub. Date: May 9, 2013

(54) OZONE-AIDED COMBUSTION SYSTEM AND METHOD

(71) Applicant: Daniel M. Brown, Grand Prairie, TX (US)

(72) Inventor: Daniel M. Brown, Grand Prairie, TX (US)

(21) Appl. No.: 13/659,413

(22) Filed: Oct. 24, 2012

Related U.S. Application Data
(60) Provisional application No. 61/628,710, filed on Nov. 5, 2011.

(51) Int. Cl. F02B 43/10

(52) U.S. Cl. 123/3

(57) ABSTRACT

An ozone-aided combustion system and method that provides for increased fuel efficiency and reduces the hydrocarbon output in internal combustion engines is disclosed. The system/method incorporates pre-combustion ozone production via an ozone generator to improve the ignition/combustion cycle in an internal combustion engine. Some preferred embodiments incorporate an air dryer for reducing the moisture content of the incoming air to improve ozone production over a range of ambient humidity conditions. Alternate preferred embodiments may incorporate a hydrolysis unit to generate dry oxygen to be added to the intake air stream of the ozone generator and/or hydrogen to be added to the downstream exhaust of the ozone generator to both enhance the production of ozone, improve the combustion efficiency of the internal combustion engine and to reduce the pollution generated by the engine. Computer control of the air dryer, ozone generator, and/or hydrolysis unit is anticipated as well as integration with vehicle control computers via standardized bus interfaces such as OBD-II.

This patent application claims the benefit of U.S. Provisional Application No. 61/628,710 filed Nov. 5, 2011. This patent application includes by reference U.S. Pat. No. 7,966,742 for AIR DRYER FOR OZONE-AIDED COMBUSTION issued to Daniel Mac Brown and Bobby Joe Farmer on Jun. 28, 2011.

### BACKGROUND OF THE INVENTION

1. Field of the Invention

The present invention generally relates to systems and methods to promote enhanced fuel economy and reduced pollution generation when applied to internal combustion engines. This invention can be generally described as belonging to one or more of the following U.S. Classifications: 123/539; 204/176.

2. Description of the Prior Art

The prior art teaches that the addition of ozone to the combustion mixture of an internal combustion engine improves performance. However, the prior art has yet to teach a practical method of integrating ozone generators within the framework of a fuel efficient internal combustion engine system.

The prior art may be generally represented by the following United States patents:

U.S. Pat. No. 4,308,844 issued to James G. Persinger for METHOD AND APPARATUS FOR IMPROVING EFFICIENCY IN COMBUSTION ENGINES on Jan. 5, 1982 which describes a method and apparatus for improving the efficiency of an internal combustion engine by producing ozone gas and positively charged air particles in a supply of air to an engine. The apparatus comprises an ozone generator cell suitably positioned with respect to the engine so that an air supply to the engine passes between adjacent plates of the ozone generator. In one embodied form, the apparatus comprises a tubular ozone generator cell for charging and ionizing a relatively small volume of air to the engine. The air supply to the generator may be first treated to substantially remove ambient moisture by means of a suitable air dryer. Optionally, a plurality of generators may be connected in sequence to provide an increased source of ozone gas to the engine thereby to commensurately reduce fuel consumption and exhaust gas emissions.

U.S. Pat. No. 6,990,965 issued to Birasak Varasundharosoth and Somroj Phanichamnuay for COMBUSTION-ENGINE AIR-INTAKE OZONE AND AIR ION GENERATOR on Jan. 31, 2006 describes an engine power booster comprising an electronic voltage generator that converts the direct current (DC) battery voltage of a vehicle at a power input, into an AC ripple voltage of 2.8-5.0 KV peak-to-peak at 2.4-4.0 KHz, that includes a DC voltage of 2.0-0.5. KV which are provided at an electrode output. A wire electrode is connected to the electrode output, and comprises a simple insulated stranded wire stripped bare at a distal end. A corona discharge generates ozone at the distal end during operation inside an internal combustion engine's air intake duct. Such ozone intake increases engine power and fuel efficiency.

U.S. Pat. No. 7,700,052 issued to Soo Hwan Jo for OZONE GENERATOR on Apr. 20, 2010 which describes a an ozone generator for generating ozone using high voltage discharging between an electrode plate forming a first electrode and a heat sink forming a second electrode. The ozone generator includes: an inner tube and a middle tube each of which is concentrically disposed, the electrode plate being interposed between the inner tube and the middle tube; an adhesive sealing both ends of the electrode plate; an electrode pipe for electrically connecting to a power source and disposed within the electrode plate; a passage formed through a middle of the heat sink; and an outer tube installed in an inner periphery surface of the passage, the outer tube being concentrically disposed to maintain a predetermined distance from an outer periphery surface of the middle tube.

U.S. Pat. No. 7,966,742 issued to Daniel Mac Brown and Bobby Joe Farmer on Jun. 28, 2011 describes a method for increasing the efficiency of an internal combustion engine utilizes three three-way valves, one that receives ambient air through an air cleaner, a second that receives hot exhaust from a catalytic converter of the internal combustion engine, and a third that receives air from a high speed blower. The three-way valves direct ambient air through the air cleaner and into a first of three dryer canisters, and direct the dried ambient air through an ozone generator to the internal combustion engine, while concurrently directing gas from the exhaust catalytic converter to the second of the three dryer canisters, and also concurrently directing air from the high speed blower to the third of the three dryer canisters.

There is a need to modulate ozone production in response to environmental factors as well as varying demands made by the internal combustion engine serviced by the ozone generator.

Accordingly, the present invention, inter alia, provides an ozone-aided combustion system/method that modulates ozone production in response to environmental factors and provides an ozone-aided combustion system/method that modulates ozone production in response to the needs of the internal combustion engine serviced by the ozone generator.

While the foregoing should not be understood to limit the teachings of the present invention, in general these features are achieved in part or in whole by the disclosed invention that is discussed in the following sections. One skilled in the art will no doubt be able to select aspects of the present invention as disclosed to affect any combination of the objectives described above.

### BRIEF SUMMARY OF THE INVENTION

The present invention context generally involves a number of Ozone-Aided Combustion System (OACS) and Ozone-Aided Combustion Method (OACM) embodiments. Generally speaking, the term OACS will deal with the invention apparatus and the term OACM will deal with the invention methods utilizing some OACS embodiment.

1. System Overview (0100)

The present invention system attempts to increase the fuel efficiency of internal combustion engines by promoting the use of ozone as an oxidizing accelerant within the internal combustion engine ignition/combustion cycle and to reduce the hydrocarbon output of the engine. The OACS system context is generally illustrated in FIG. 1 (0100) wherein the OACS (0110) comprises the following elements:
a. Air pre-processor (0111);
b. Oxygen/fuel source (0112);
c. Ozone generator (0115);
d. High voltage power supply (0116);
e. Environmental sensors (0117); and
f. Control computer (0118);
wherein
the air pre-processor (0111) receives air from an air source to produce pre-processed air;
the oxygen/fuel source (0112) optionally supplies additional oxygen (0113) to said ozone generator (0115) and/or additional fuel—hydrogen-(0114) to the internal combustion engine (0101);
the ozone generator (0115) takes the pre-processed air and/or the additional oxygen (0113) to generate ozone for use in an internal combustion engine (0101);
the high voltage power supply (0116) provides voltages necessary for proper operation of the ozone generator (0115); the environmental sensors (0117) monitor the ambient conditions of
the internal combustion engine (0101); and
the control computer (0118) modulates the operation of the air pre-processor (0111), the optional oxygen/fuel source(s) (0112), and the high voltage power supply (0116) in response to input from the environmental sensors (0117) and demand from the internal combustion engine (0101).

This general OACS forms the basis for a number of system and method embodiments that generate ozone in response to environmental conditions to aid in the combustion characteristics of the internal combustion engine (0101).

2. Method Overview (0200)

As generally illustrated in FIG. 2 (0200), the present invention teaches an Ozone-Aided Combustion Method (OACM) having the following steps:

Receiving air intake from an air source (0201);
Pre-processing the air intake to/from one or more oxygen source(s) (0202);
Injecting the oxygen source(s) into an ozone generator (0203);
Converting the oxygen source(s) to ozone in the ozone generator (0204);
Transferring the ozone and/or additional fuel to an internal combustion engine (0205);
Monitoring the environmental conditions associated with the internal combustion engine (0206); and
Varying the air pre-processor and the ozone generator output based on the environmental conditions by controlling the step 2 (202) and the step 4 (204) as required based on the requirements of the internal combustion engine (0207).

One skilled in the art will recognize that these steps may be rearranged without detracting from the teachings of the present invention, and may be augmented with the previously disclosed system embodiments with no loss of generality in the teachings of the invention.

### BRIEF DESCRIPTION OF THE DRAWINGS

For a fuller understanding of the advantages provided by the invention, reference should be made to the following detailed description together with the accompanying drawings wherein:

FIG. 1 illustrates a generalized block diagram of a preferred system embodiment the present invention;

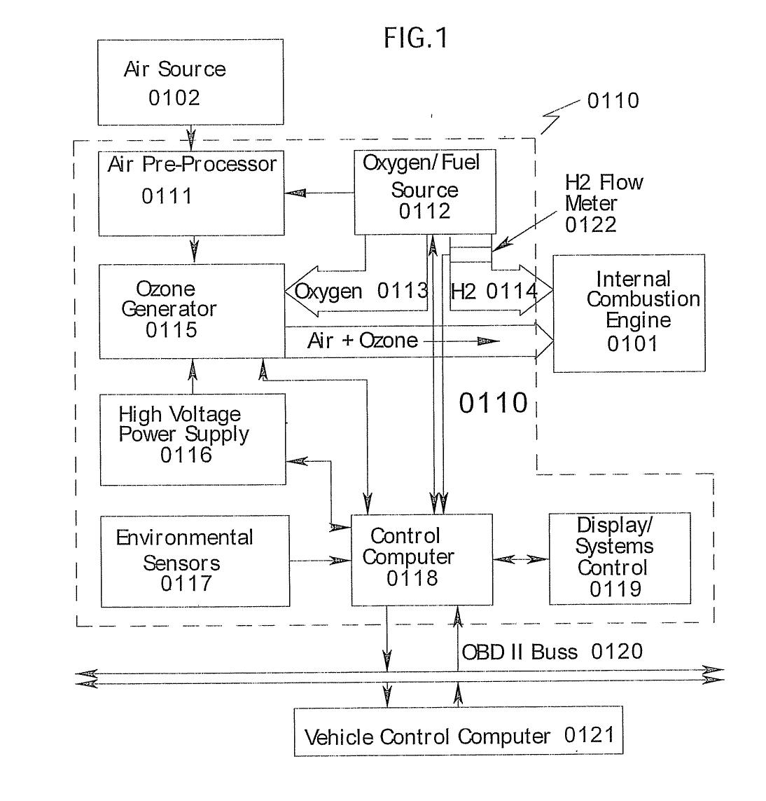

FIG. 2 illustrates a generalized process flowchart of a preferred method embodiment of the present invention;

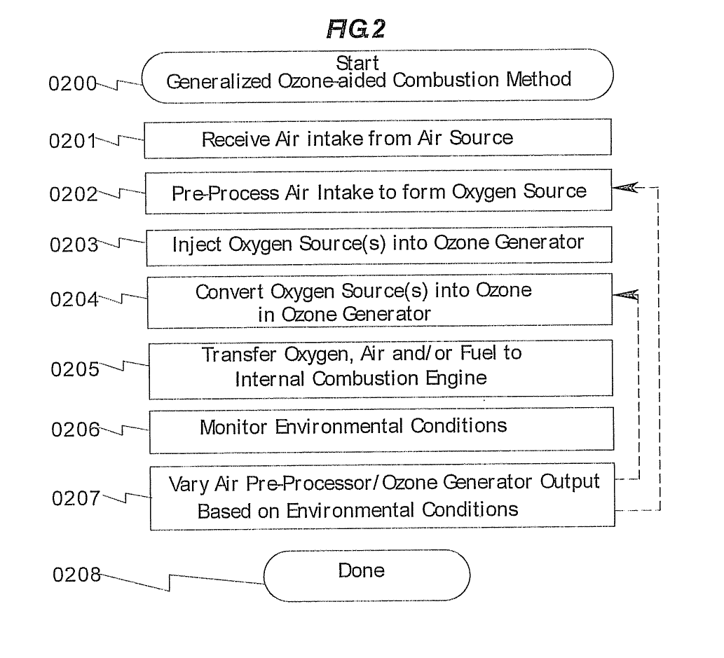

FIG. 3 illustrates a graph of ozone efficiency as a function of dewpoint;

FIG. 4 illustrates an exemplary compensation curve useful in providing environmental dewpoint compensation for some preferred embodiments of the present invention;

FIG. 5 illustrates a block diagram of a preferred system embodiment the present invention utilizing an air dryer as an air pre-processor within the present invention;

FIG. 6 illustrates a generalized process flowchart of a preferred method embodiment of the present invention utilizing air drying as an air pre-processing subsystem within the context of the present invention;

FIG. 7 illustrates a block diagram of a preferred system embodiment the present invention utilizing an air dryer as an air pre-processor and a hydrolysis unit to provide additional oxygen to the ozone generator and hydrogen fuel within the present invention;

FIG. 8 illustrates a generalized process flowchart of a preferred method embodiment of the present invention utilizing air drying as an air pre-processing subsystem within the context of the present invention and a hydrolysis unit to provide an additional oxygen and fuel source;

FIG. 9 illustrates a generalized display/system control unit incorporating an OBD-II interface useful in some preferred embodiments of the present invention and a generalized and simplified display/system control unit useful in some preferred embodiments of the present invention;

FIG. 10 illustrates an exemplary system application architecture associated with many preferred embodiments of the present invention.

FIG. 11 is a cross-sectional view of the ozone generator associated with many preferred embodiments of the present invention.

FIG. 12 is a top view and edge view of the ozone generator sandwich of FIG. 11 and associated with many preferred embodiments of the present invention.

FIG. 13 is a plan view of the hydrolysis unit associated with many preferred embodiments of the present invention.

### DESCRIPTION OF THE PREFERRED EMBODIMENT

While this invention is susceptible of embodiment in many different forms, there is shown in the drawings and will herein be described in detailed preferred embodiment of the invention with the understanding that the present disclosure is to be considered as an exemplification of the principles of the invention and is not intended to limit the broad aspect of the invention to the embodiment illustrated.

The numerous innovative teachings of the present application will be described with particular reference to the presently preferred embodiment, wherein these innovative teachings are advantageously applied to the particular problems of an OZONE-AIDED COMBUSTION SYSTEM AND METHOD. However, it should be understood that this embodiment is only one example of the many advantageous uses of the innovative teachings herein. In general, statements made in the specification of the present application do not necessarily limit any of the various claimed inventions. Moreover, some statements may apply to some inventive features but not to others.

### Materials not Limitive

The present invention may be constructed of a variety of materials, including but not limited to plastic, metal, ceramic, etc. The general construction illustrated herein is not intended to limit the scope of materials suitable for this application.

### Ozone Generator not Limitive

While the present invention anticipates many embodiments will be implemented using a corona discharge ozone generator, the present invention is not limited to this type of ozone generation system and therefore the ozone generation depicted within this document is to be given its broadest possible interpretation as applied to the teachings of the present invention as shown herein.

### Ozone Generation Overview

### 1. Production

Ozone often forms in nature under conditions where O2 will not react. Ozone used in industry is measured in μmol/mol (ppm, parts per million), nmol/mol (ppb, parts per billion), μg/m3, mg/hr (milligrams per hour) or weight percent. The regime of applied concentrations ranges from 1 to 5% in air and from 6 to 14% in oxygen for older generation methods. New electrolytic methods can achieve up 20 to 30% dissolved ozone concentrations in output water.

Temperature and humidity plays a large role in how much ozone is being produced using traditional generation methods such as corona discharge and ultraviolet light. Old generation methods will produce less than 50% its nominal capacity if operated with humid ambient air than when it operates in very dry air. New generators using electrolytic methods can achieve higher purity and dissolution through using water molecules as the source of ozone production.

### 2. Corona Discharge Method

This is the most common type of ozone generator for most industrial and personal uses. While variations of the “hot spark” coronal discharge method of ozone production exist, including medical grade and industrial grade ozone generators, these units usually work by means of a corona discharge tube. They are typically cost-effective and do not require an oxygen source other than the ambient air to produce ozone concentrations of 3-6%. Fluctuations in ambient air, due to weather or other environmental conditions, cause variability in ozone production. However, they also produce nitrogen oxides as a by-product. Use of an air dryer can reduce or eliminate nitric acid formation by removing water vapor and increase ozone production. Use of an oxygen concentrator can further increase the ozone production and further reduce the risk of nitric acid formation by removing not only the water vapor, but also the bulk of the nitrogen.

### 3. Ultraviolet Light

UV ozone generators, or vacuum-ultraviolet (VUV) ozone generators, employ a light source that generates a narrow-band ultraviolet light, a subset of that produced by the Sun. The Sun's UV sustains the ozone layer in the stratosphere of the Earth.

While standard UV ozone generators tend to be less expensive, they usually produce ozone with a concentration of about 0.5% or lower. Another disadvantage of this method is that it requires the air (oxygen) to be exposed to the UV source for a longer amount of time, and any gas that is not exposed to the UV source will not be treated. This makes UV generators impractical for use in situations that deal with rapidly moving air or water streams (in-duct air sterilization, for example). Production of ozone is one of the potential dangers of ultraviolet germicidal irradiation. VUV ozone generators are used in swimming pool and spa applications ranging to millions of gallons of water, VUV ozone generators, unlike corona discharge generators, do not produce harmful nitrogen by-products and also unlike corona discharge systems, VUV ozone generators work extremely well in humid air environments. There is also not normally a need for expensive off-gas mechanisms, and no need for air driers or oxygen concentrators, that require extra costs and maintenance.

### 4. Cold Plasma

In the cold plasma method, pure oxygen gas is exposed to a plasma created by dielectric barrier discharge. The diatomic oxygen is split into single atoms, which then recombine in triplets to form ozone.

Cold plasma machines utilize pure oxygen as the input source and produce a maximum concentration of about 5% ozone. They produce far greater quantities of ozone in a given space of time compared to ultraviolet production. However, because cold plasma ozone generators are very expensive, they are found less frequently than the previous two types.

The discharges manifest as filamentary transfer of electrons (micro discharges) in a gap between two electrodes. In order to evenly distribute the micro discharges, a dielectric insulator must be used to separate the metallic electrodes and to prevent arcing.

Some cold plasma units also have the capability of producing short-lived allotropes of oxygen which include O4, O5, O6, O7, etc. These species are even more reactive than ordinary O3.

### 5. Electrolytic

Electrolytic ozone generation (EOG) splits water molecules into H2, O2, and O3. In most EOG methods, the hydrogen gas will be removed to leave oxygen and ozone as the only reaction products. Therefore, EOG can achieve higher dissolution in water without other competing gases found in corona discharge method, such as nitrogen gases present in ambient air. This method of generation can achieve concentrations of 20-30% and is independent of air quality because water is used as the starting substrate.

### 6. Ozone Generation Efficiency vs. Dewpoint (0300, 0400)

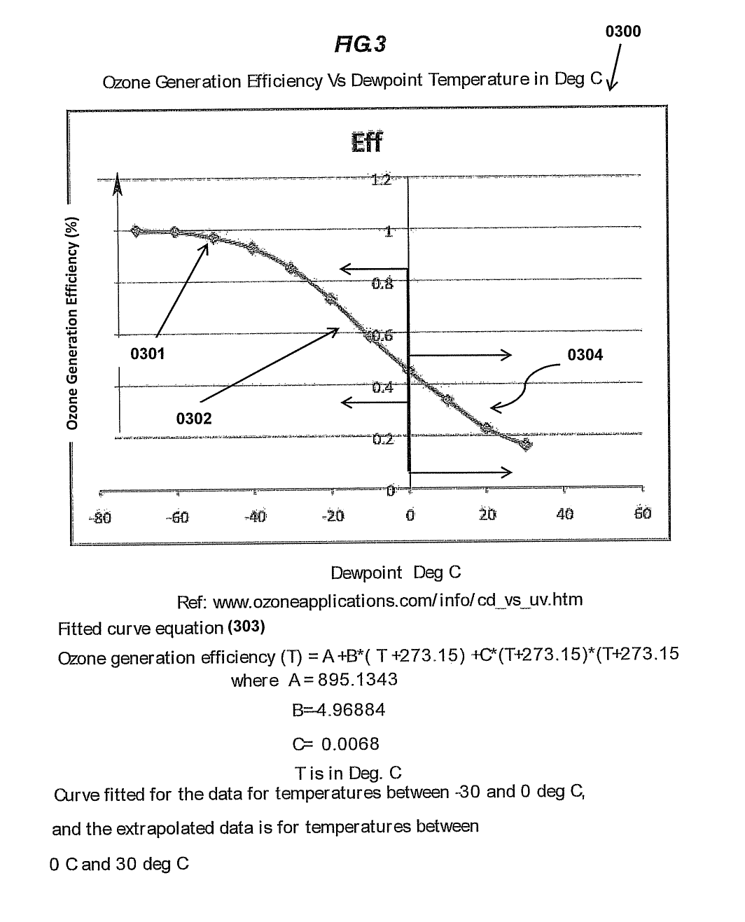

A goal of the present invention is the utilization of ozone to aid combustion within a wide variety of environmental conditions. An important environmental condition is the relative humidity (measured as dewpoint) of the air in which the ozone is generated. As is generally seen by the ozone generation efficiency vs. dewpoint curve in FIG. 3 (0300), ozone generation efficiency is strongly influenced by the air humidity. The measured data (0301) and fitted curve (0302) indicate a non-linear decline in ozone generation with increasing temperature. An exemplary fitted curve equation and corresponding equation coefficients (0303) are provided as an aid in understanding this ozone efficiency vs. dewpoint phenomenon.

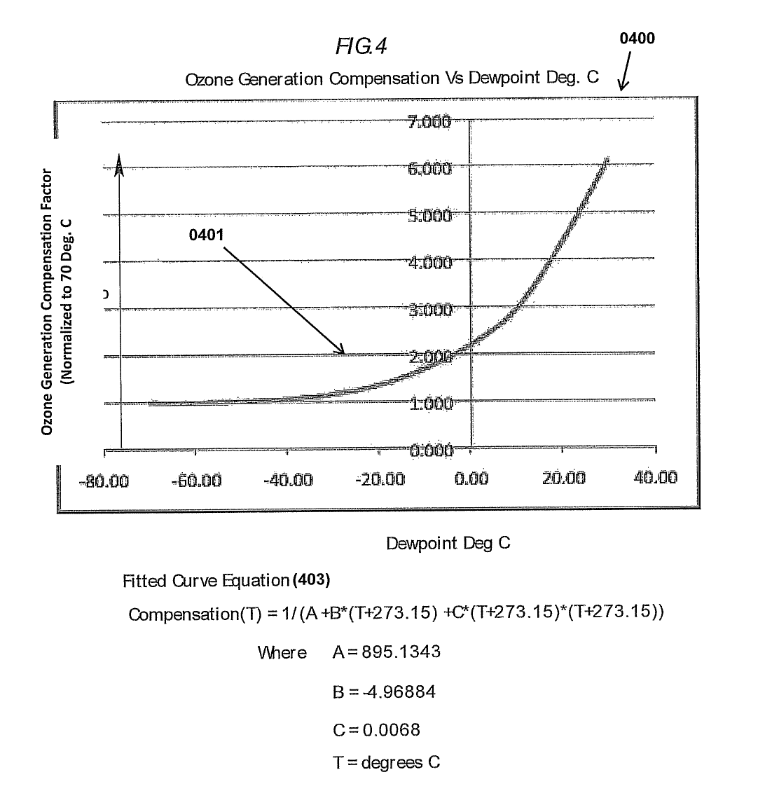

This information can be used to generate a compensation curve and associated equation as generally illustrated in FIG. 4 (0400). Here the compensation characteristic curve (0401) is presented as derived from the fitted curve (0302) of FIG. 3 (0300) and normalized to unity gain at −70 degrees Celsius. A corresponding fitted curve equation and coefficients (0403) are provided for reference in implementing this compensation characteristic. One skilled in the art will recognize that other functional forms of compensation equation are possible including a variety of exponential functions including fractional forms thereof, such as EXP(X), X**(3/2), etc.

Note that whether the ozone generation dewpoint compensation is performed digitally or by analog means, the characteristic illustrated in FIG. 4 (0400) is implemented in many preferred optimal embodiments to ensure that ozone production is not significantly reduced due to air humidity increases. This is especially important in internal combustion engines, as the ambient dewpoint of the atmosphere near the internal combustion engine can vary widely.

### 7. Ozone Generation Efficiency vs. Pressure

A goal of the present invention is the utilization of ozone to aid combustion within a wide variety of environmental conditions. An important environmental condition is the atmospheric pressure (and/or altitude) of the air in which the ozone is generated. As discussed herein, ozone generation efficiency is significantly influenced by the air humidity. Note that whether the ozone generation altitude/pressure compensation is performed digitally or by analog means, adjustments may be implemented in many preferred optimal embodiments to ensure that ozone production is not significantly reduced due to altitude increases. This relationship may be especially important in internal combustion engines, as the altitude at which the internal combustion engine operates can vary widely. In a test situation in 2007, in a trip from Flagstaff Ariz. at 6600 foot altitude in a 2005 Dodge van to the Grand Canyon rim at an 8800 foot altitude, and return, the fuel mileage was constant at 32 miles/gallon, the same as it was in five days of trips around Phoenix, Ariz. at a 1500 foot altitude.

### 8. Ozone Generation Efficiency vs. Temperature (0700, 0800)

A goal of the present invention is the utilization of ozone to aid combustion within a wide variety of environmental conditions. An important environmental condition is the ambient air temperature in which the ozone is generated. Ozone generation efficiency is strongly influenced by the ambient air temperature. Note that whether the ozone generation temperature compensation is performed digitally or by analog means, adjustments may be implemented in many preferred optimal embodiments to ensure that ozone production is not significantly reduced due to air temperature increases.

### 9. Exemplary System Embodiment—Air Dryer (0900)

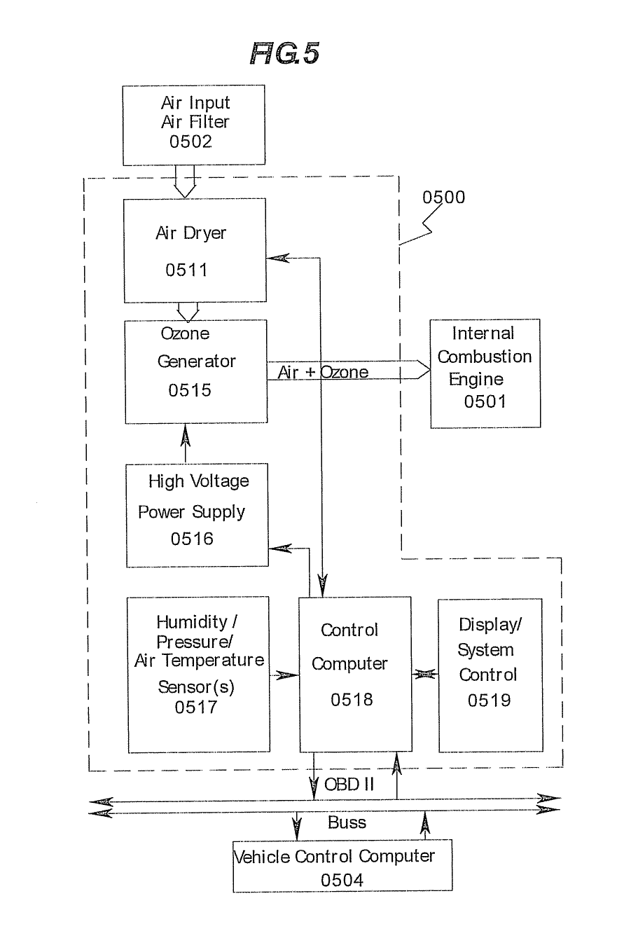

While the present invention teaches a number of preferred exemplary embodiments, one preferred embodiment of the OACS principle is generally illustrated in FIG. 5 (0500), wherein the air pre-processing function incorporates an air dryer (0511). This exemplary OACS system context is generally illustrated in FIG. 5 (0500) wherein the OACS (0510) comprises the following elements:
Air dryer (0511);
Ozone generator (0515);
High voltage power supply (0516);
Humidity/pressure/air temperature sensors (0517);
Control computer (0518); and
Display/system control unit (0519);
wherein
the air dryer (0511) receives air from an air input/air filter (0502) to produce dried air;
the ozone generator (0515) takes the dried air to generate ozone for use in an internal combustion engine (0501);
the high voltage power supply (0516) provides voltages necessary for proper operation of the ozone generator (0515);
the humidity/pressure/air temperature sensors (0517) monitor the ambient conditions of the air intake of the internal combustion engine (0501);
the control computer (0518) modulates the operation of the air dryer (0511) and the high voltage power supply (0516) in response to input from the humidity/pressure/air temperature sensors (0517) and demand from the internal combustion engine (0501); and
the display/system control unit (0519) permits configuration and monitoring of the computer control system (0518) that modulates the overall operation of the OACS (0510).

This general OACS forms the basis for a number of system and method embodiments that generate ozone in response to environmental conditions to aid in the combustion characteristics of the internal combustion engine (0501). As discussed previously, the control computer (0518) can modulate operation of the air dryer (0511) and ozone generator (0515) in response to changes in ambient humidity, temperature, altitude, and engine RPM to ensure that the fuel economy performance of the internal combustion engine (0501) is optimally maintained. Modulation may include, but is not limited to, increasing/decreasing the dried air supplied to the ozone generator (0515), increasing/decreasing the oxygen supplied to the ozone generator (0515), increasing/decreasing the supply of fuel to the engine (0501), increasing/decreasing the voltage to the ozone generator (0515), and/or increasing/decreasing the voltage to the air dryer (0511).

As illustrated in FIG. 5 (0500), the control computer (0518) may communicate via a conventional OBD-II bus (0503) to a vehicle control computer (0504) to provide additional monitoring and control capabilities consistent with the overall fuel economy performance and exhaust emission goals of the overall vehicle engine control system. Although an OBD-II bus (0503) forms the basis for a number of system and method embodiments, the systems and embodiments are not limited to such a bus (0503). Rather, the invention may be implemented with other on-board diagnostic systems which may be available or which may be developed in the future.

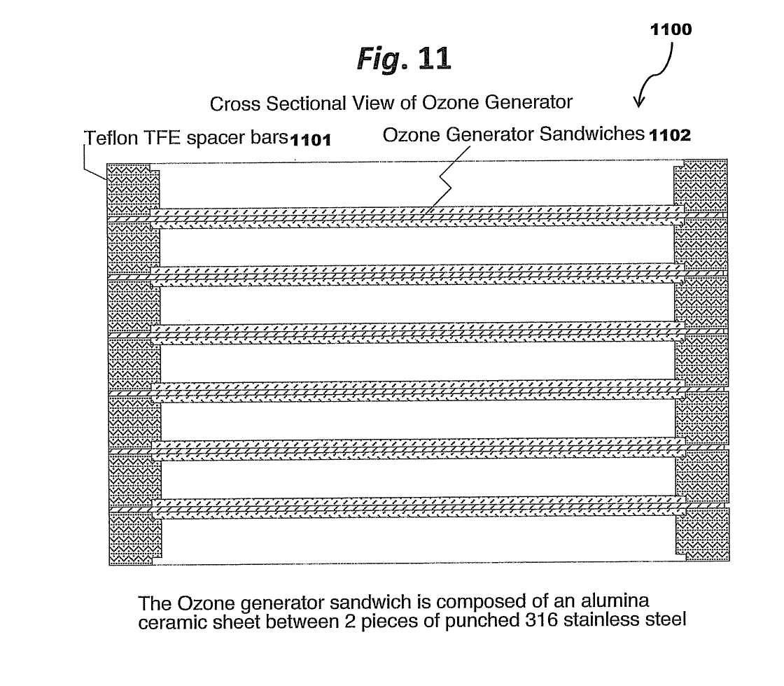

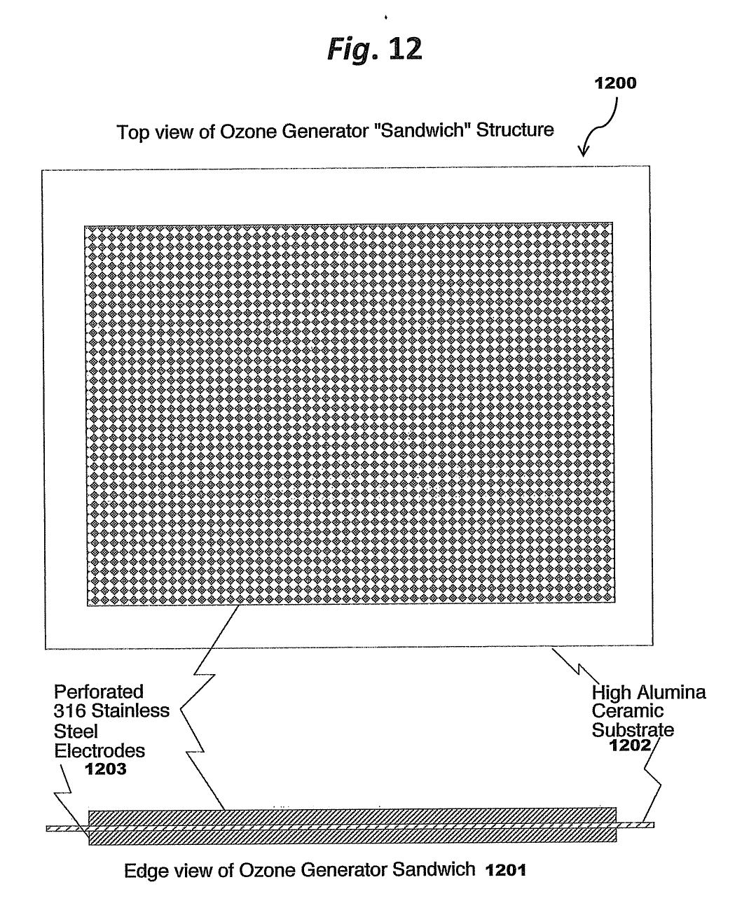

As illustrated in FIGS. 11 & 12, the ozone generator (1100) of the preferred embodiment comprises a plurality of ozone generator sandwiches (1102) and spacer bars (1101) which separate each ozone generator sandwich (1102) from the other. In the preferred embodiment, the spacer bars (1101) are composed of Teflon TEE. The sandwiches (1102) are composed of an alumina ceramic sheet positioned between pieces of punched 316 stainless steel. In FIG. 12, there is shown a top and edge view of the ozone sandwich structure (1200) of the ozone sandwich (1201) (1102 of FIG. 11). As shown in FIG. 12, each sandwich (1201) comprises 316 stainless electrodes (1203) and a high alumina ceramic substrate (1202).

### 10. Exemplary Method Embodiment—Air Dryer (0600)

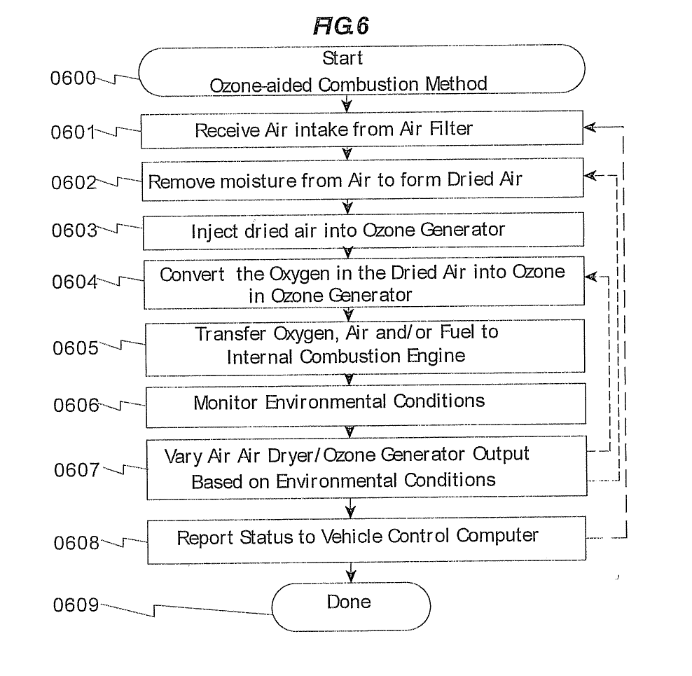

The above described system embodiment in FIG. 5 (0500) may have an associated invention method embodiment as depicted in FIG. 6 (0600). As generally illustrated in FIG. 6 (0600), the present invention teaches an associated Ozone-Aided Combustion Method (OACM) having the following steps:
Receiving air intake from an air input/air filter source (0601);
Removing moisture from said air intake to form dried air (0602);
Injecting the dried air into an ozone generator (0603);
Converting the dried air to ozone in the ozone generator (0604);
Transferring the ozone to an internal combustion engine (engine) (0605);
Monitoring the humidity, pressure, and temperature conditions associated with the internal combustion engine (0606);
Varying the air dryer and the ozone generator output based on the humidity, pressure, and temperature conditions by controlling the step (2) (0602) and the step (4) (0604) as required based on the requirements of the internal combustion engine (0607); and
Reporting the status of the air dryer and the ozone generator to the OACS control computer (0608).
One skilled in the art will recognize that these steps may be rearranged without detracting from the teachings of the present invention, and may be augmented with the previously disclosed system embodiments with no loss of generality in the teachings of the invention.

### 11. Exemplary System Embodiment—Hydrolysis Device (0700)

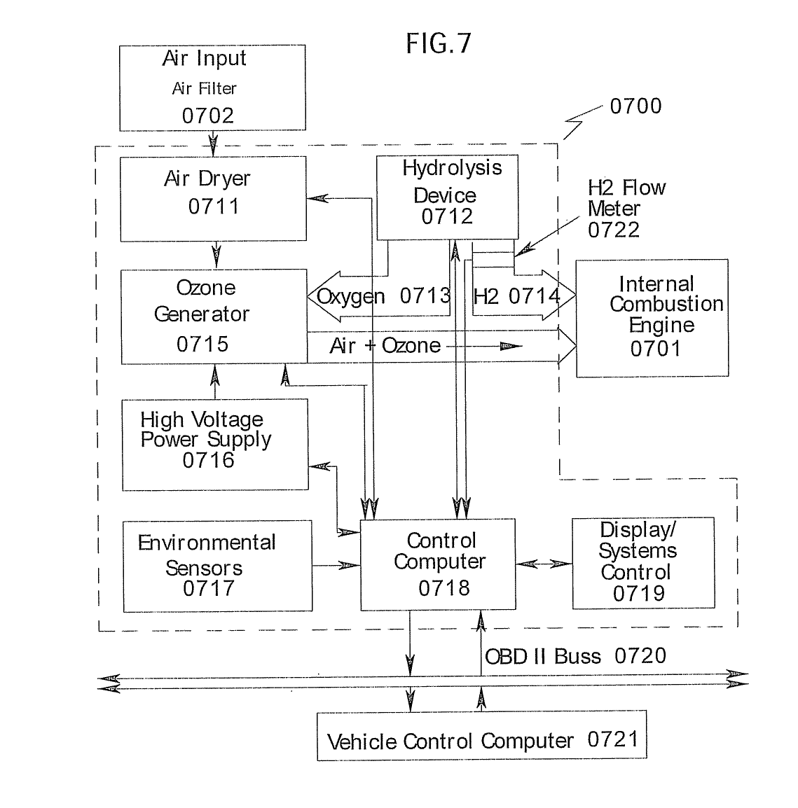

While the present invention teaches a number of preferred exemplary embodiments, one preferred embodiment of the OACS principle is generally illustrated in FIG. 7 (0700), wherein the air pre-processing function incorporates an air dryer (0711) as well as a hydrolysis device (0712) used to provide additional oxygen (0713) and/or supplemental hydrogen fuel (0714). This exemplary OACS system context is generally illustrated in FIG. 7 (0700) wherein the OACS (0710) comprises the following elements:
Air dryer (0711);
Hydrolysis device (0712) having oxygen (0713) and hydrogen (0714) outputs;
Ozone generator (0715);
High voltage power supply (0716);
Humidity/pressure/air temperature sensors (0717);
Control computer (0718); and
Display/system control unit (0719);
wherein
the air dryer (0711) receives air from an air input/air filter (0702) to produce dried air;
the ozone generator (0715) takes the dried air to generate ozone for use in an internal combustion engine (engine) (0701);
the hydrolysis device (0712) takes water and converts it to oxygen (0713) for input to the ozone generator (0715) and hydrogen (0714) for input to the internal combustion engine (engine) (0701);
the high voltage power supply (0716) provides voltages necessary for proper operation of the ozone generator (0715);
the humidity/pressure/air temperature sensors (0717) monitor the ambient conditions of the internal combustion engine (engine) (0701);
the control computer (0718) modulates the operation of the air dryer (0711), the high voltage power supply (0716), and the hydrolysis device (0712) in response to input from the humidity/pressure/air temperature sensors (0717) and demand from the internal combustion engine (engine) (0701); and
the display/system control unit (0719) permits configuration and monitoring of the computer control system (0718) that modulates the overall operation of the OACS (0710).

This general OACS forms the basis for a number of system and method embodiments that generate ozone in response to environmental conditions to aid in the combustion characteristics of the internal combustion engine (0701). As discussed previously, the control computer (0718) can modulate operation of the air dryer (0711), ozone generator (0715), and hydrolysis device (0712) in response to changes in ambient humidity, temperature, altitude, and engine RPM to ensure that the fuel economy performance of the internal combustion engine (0701) is optimally maintained. Modulation may include, but is not limited to, increasing/decreasing the dried air supplied to the ozone generator (0715), increasing/decreasing the oxygen supplied to the ozone generator (0715), increasing/decreasing the voltage to the ozone generator (0715), and/or increasing/decreasing the voltage to the air dryer (0711) and/or increasing/decreasing the oxygen and/or hydrogen output of the hydrolysis unit (0712) such that the supply of such oxygen to the ozone generator (0715) and the supply of hydrogen to the engine (0701) may be varied in response to changing conditions.

As illustrated in FIG. 7 (0700), the control computer (0718) may communicate via a conventional OBD-II bus (0703) to a vehicle control computer (0704) to provide additional monitoring and control capabilities consistent with the overall fuel economy performance and exhaust emission goals of the overall vehicle engine control system. Although an OBD-II bus (0703) forms the basis for a number of system and method embodiments, the systems and embodiments are not limited to such a bus (0703). Rather, the invention may be implemented with other on-board diagnostic systems which may be available or which may be developed in the future.

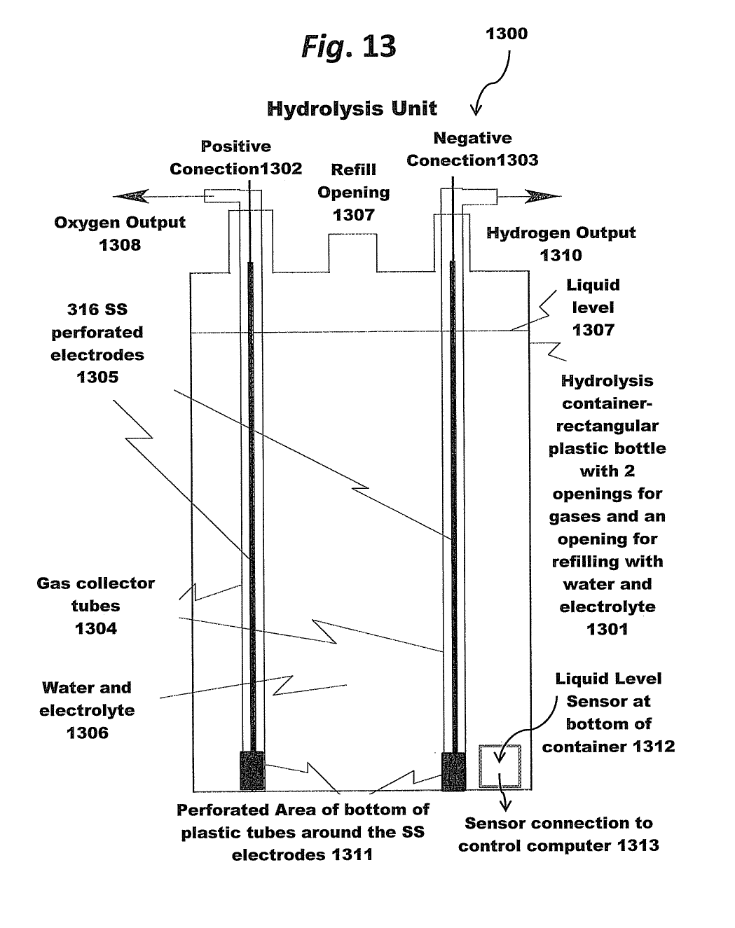

As illustrated in FIG. 13, the hydrolysis unit (1300) of the preferred embodiment comprises a container (1301) comprising positive (1302) and negative (1303) connections, gas collector tubes (1304), and electrodes (1305). The container (1301) may be filled with water and electrolyte (1306) through a refill opening (1307). A liquid level sensor (1312) is positioned at the bottom of the container (1301) and is adapted to determine a liquid level (1307) in the container (1301). The sensor (1312) is operatively coupled (1313) to the control computer. Gas collected as a result of the hydrolysis collects in the tubes (1304) such that oxygen may be released from an oxygen output opening (1308), and hydrogen may be released from a hydrogen output opening (1310). In the preferred embodiment, the container (1301) is a generally rectangular plastic container (1301). The electrodes (1305) are perforated and formed from 316 stainless steel and the tubes (1304) are formed from plastic. The tubes (1304) comprise perforations (1311) near a bottom portion around the electrodes (1305).

### 12. Exemplary Method Embodiment—Hydrolysis Device (0800)

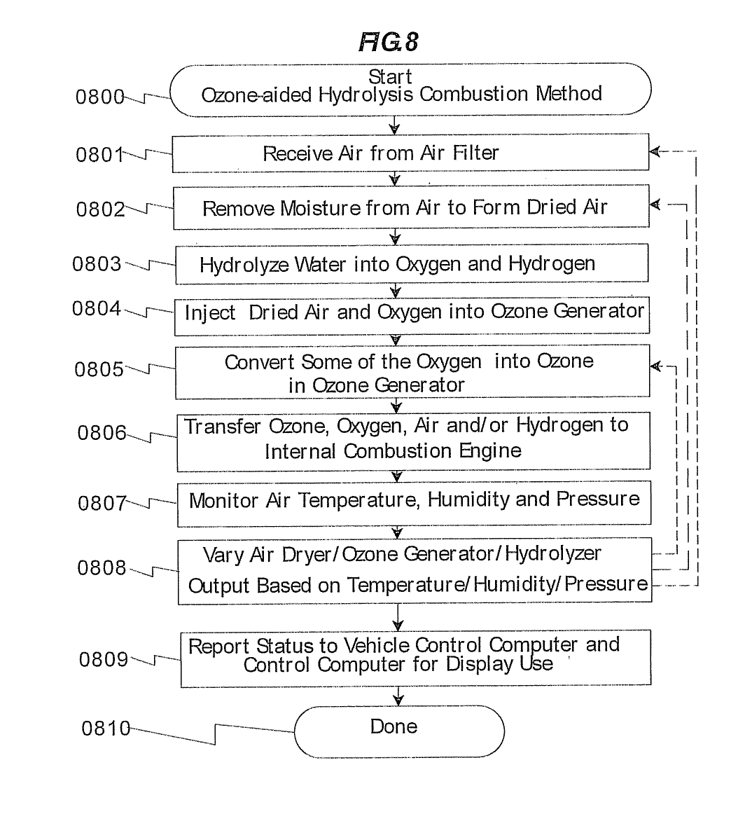

The above described system embodiment in FIG. 7 (0700) may have an associated invention method embodiment as depicted in FIG. 8 (0800). As generally illustrated in FIG. 8 (0800), the present invention teaches an associated Ozone-Aided Combustion Method (OACM) having the following steps:
Receiving air intake from an air input/air filter source (0801);
Removing moisture from said air intake to form dried air (0802);
Hydrolyzing water into hydrogen and oxygen (0803);
Injecting the hydrolyzed oxygen into an ozone generator (0804);
Injecting the dried air into the ozone generator (0804);
Converting the injected dried air and the injected oxygen to ozonated air (air containing ozone) in the ozone generator (0805);
Injecting the hydrolyzed hydrogen into an internal combustion engine (engine) (0806);
Transferring the ozonated air to the internal combustion engine (engine) (0806);
Monitoring the humidity, pressure, and temperature conditions of the input air stream of the internal combustion engine (engine) (0807), the flow rate of the hydrogen into the engine intake and the ozone concentration out of the ozone generator (0808);
Varying the air dryer, the ozone generator output, and hydrolyser output based on the humidity, pressure, and temperature conditions by controlling the step (2), the step (3), and the step (4) as required based on the requirements of the internal combustion engine (engine)(0808); and
Reporting the status of the air dryer and the ozone generator to the OACS control computer (0809).

One skilled in the art will recognize that these steps may be rearranged without detracting from the teachings of the present invention, and may be augmented with the previously disclosed system embodiments with no loss of generality in the teachings of the invention.

### 13. Display/System Control (0900)

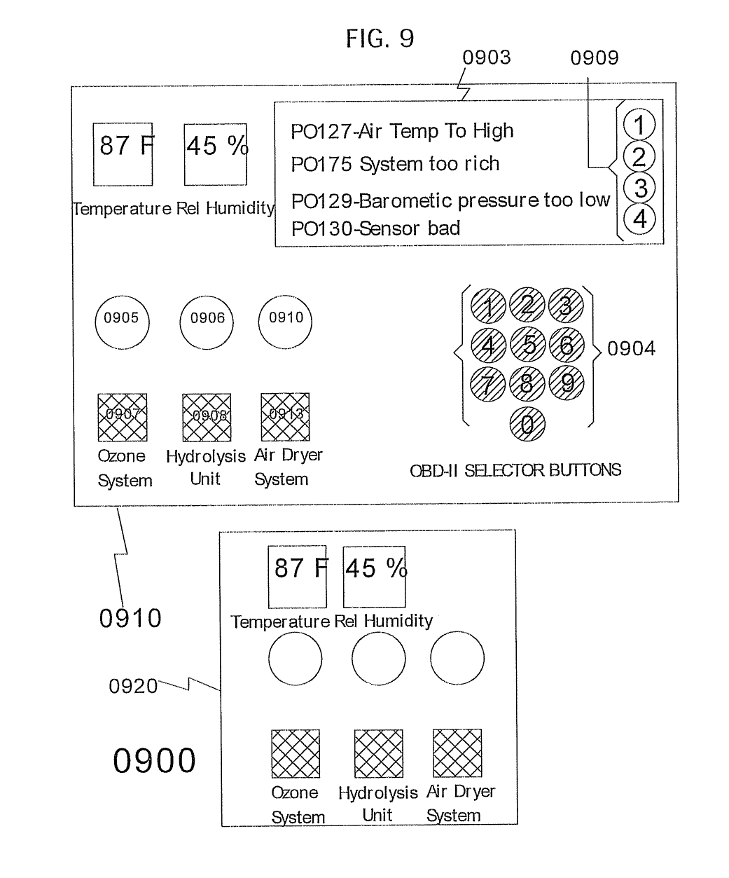

While the display/system control blocks (0519, 0719) generally illustrated in FIG. 5 (0500) and FIG. 7 (0700) may be implemented in a wide variety of configurations, some preferred embodiments of these user interfaces are generally illustrated in FIG. 9 (0900).

Referencing FIG. 9 (0900), in an exemplary display/control interface embodiment (0910), the top left LCD display (0901) presents the temperature measured by the temperature sensor of the temperature and relative humidity measurement unit. This display could be in Degrees Fahrenheit or Degrees Centigrade.

The top middle LCD display (0902) presents the relative humidity or incoming air moisture content of the incoming air stream.

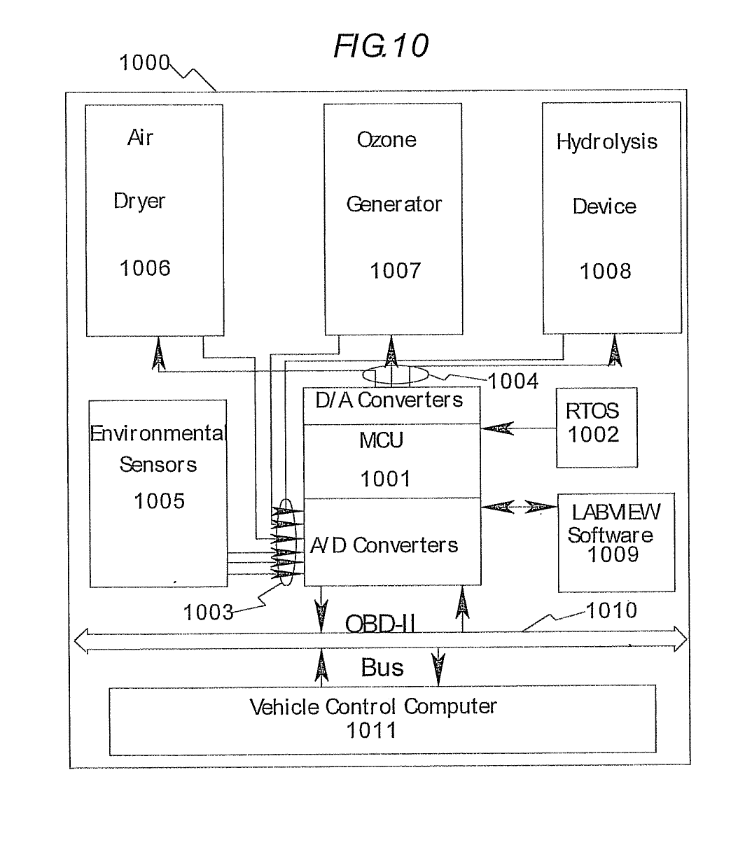

The top right side LCD display (0903) presents four readings from the OBD-II engine and entire vehicle measurement system, and represents an optional display. If this display is not integrated into the display subsystem, neither the OBD-II LCD display (0903) nor the OBD-II selector buttons (0904) will be configured, and the resulting display interface will be as depicted in FIG. 10 (1000).

The left hand circle (0905) is an LED readout driven by the ozone generator system it will optimally indicate red if not performing properly and green if performing properly.

The middle circle (0906) is an LED readout driven by the Hydrolysis unit. It will optimally indicate green if it is performing properly and indicate red if not performing properly.

The right hand circle (0911) is a LED display that is green when the air dryer is working properly and red when it is malfunctioning.

The lower left cross-hatched square (0907) is an on-off pushbutton switch to turn off or on the ozone generator system.

The lower middle cross-hatched square (0908) is an on-off pushbutton switch to turn on or off the hydrolysis unit.

The lower right hand cross hatched square (0912) is an on-off pushbutton switch to turn on or off the air dryer system.

The lower 10 buttons (0904) for are for entering OBD-II data into the control system for display in the LCD display above the button array. It is in the familiar telephone array of digits.

The right side vertical array of buttons (0909) to the right of the OBD-II LCD display (0903) is for selecting the particular OBD-II number. To enter a particular OBD-II number into the system:
1. first select which of the 4 buttons in the vertical array (0909), for example using the top one #1.
2. type in the desired 4 digit number using the 10 digit button array (0904).
   Then select the next OBD-II number to display using one of the right side buttons. Then type in the next desired OBD-II number into the 10 digit button array.

If the particular button typed is not one of those in the system for the vehicle, then “ERR” will be displayed for that erroneous number typed.

An indicator light (0906)—to alert the driver that the hydrolysis unit is low in water would optimally be a red colored LED, to show that de-mineralized water needed to be added to keep it in operation.

If it is desired that the OBD-II information be suppressed, then the control & display panel (0920) could be configured alternatively as generally illustrated in FIG. 9 (0900).

Another manifestation of the control system for the OACS will have the display system be a touch screen type where the square on/off buttons are set up as controls. And the round LED areas are set up as the display portions of the touch screen.

### 14. Exemplary Digital Control System Architecture (1000)

While the present invention may be embodied in a wide variety of forms, several preferred embodiments will incorporate a system architecture as generally illustrated in FIG. 10 (1000), wherein the system is controlled via the use of a microcontroller unit (MCU) (1001) running under control of a real-time operating system (1002). This MCU (1001) may incorporate integrated ND converters (1003) and/or D/A converters (1004) for use in communicating with environmental sensors (1005) and the air dryer (1006), ozone generator (1007) and/or hydrolysis device (1008). Many embodiments of this system architecture may incorporate application data capture and analysis software (1009), such as LABVIEW® BRAND software from National Instruments, Inc. Finally, the MCU (1001) may incorporate an OBD-II bus (1010) interface to permit communication with a vehicle control computer.

Note that this system architecture may also incorporate analog components as described below such that linearization functions associated with the environmental sensors (1005) and/or the air dryer (1006), ozone generator (1007), and/or hydrolysis device (1008) are controlled using analog signals rather than digital signals. This choice of analog/digital signal control is dependent on the specific application of the invention and is a decision that one skilled in the art can easily make based on the application constraints associated with the invention application context.

### 15. Analog Control Computer

While in many preferred embodiments the control computer may be configured as a traditional general purpose digital computer, CPU, MCU, microcontroller, programmable logic, etc., some preferred exemplary embodiments of the present invention anticipate that the control computer is configured as an analog circuit that instantaneously responds to variations in the humidity/pressure/temperature sensors to control the high voltage supply for the ozone generator, the air dryer, and/or the hydrolysis unit.

### 16. System/Method Variations

The present invention anticipates a wide variety of variations in the basic theme of construction. The examples presented previously do not represent the entire scope of possible usages. They are meant to cite a few of the almost limitless possibilities.

The present invention has a number of anticipated embodiments, many of which are preferred. Features included in some of these embodiments include the following:

An embodiment wherein the ozone generator comprises a corona discharge.

An embodiment wherein the control computer compensates for ozone generation efficiency based on the ambient temperature of the internal combustion engine and the pressure altitude of the vehicle.

Other variants are described below in detail. One skilled in the art will recognize these variants may be combined in some preferred embodiments to achieve desirable characteristics consistent with the overall teaching of the invention.

### CONCLUSION

An ozone-aided combustion system and method that provides for increased fuel efficiency and reducing the pollution generated in the exhaust in internal combustion engines has been disclosed. The system/method incorporates pre-combustion ozone production via an ozone generator to improve the ignition/combustion cycle in an internal combustion engine. Some preferred embodiments incorporate an air dryer for reducing the moisture content of the incoming air to improve ozone production over a range of ambient humidity conditions. Alternate preferred embodiments may incorporate a hydrolysis unit to generate dry oxygen to be added to the intake air stream of the ozone generator and/or hydrogen to be added to the downstream exhaust of the ozone generator to both enhance the production of ozone and improve the combustion efficiency of the internal combustion engine. Computer control of the air dryer, ozone generator, and/or hydrolysis unit is anticipated as well as integration with vehicle control computers via standardized bus interfaces such as OBD-II.

Although a preferred embodiment of the present invention has been illustrated in the accompanying drawings and described in the foregoing Detailed Description, it will be understood that the invention is not limited to the embodiments disclosed, but is capable of numerous rearrangements, modifications, and substitutions without departing from the spirit of the invention as set forth and defined by the following claims.

I claim:

1. An Ozone-Aided Combustion System (OACS) comprising:
Air pre-processor;
Oxygen/fuel source;
Ozone generator;
High voltage power supply;
Environmental sensor; and
Control computer;
wherein
said air pre-processor receives air from an air source to produce pre-processed air;
said oxygen/fuel source optionally supplies additional oxygen to said ozone generator and/or fuel to said internal combustion engine;
said ozone generator takes said pre-processed air and/or said additional oxygen to generate ozone for use in an internal combustion engine;
said high voltage power supply provides voltages necessary for proper operation of said ozone generator;
said environmental sensor monitors the ambient conditions of said internal combustion engine; and
said control computer modulates the operation of said air pre-processor, said optional oxygen/fuel source(s), and said high voltage power supply in response to input from said environmental sensors and demand from said internal combustion engine.

2. The Ozone-Aided Combustion System (OACS) of claim 1 wherein said ozone generator comprises a corona discharge.

3. The Ozone-Aided Combustion System (OACS) of claim 1 wherein said environmental sensor further comprises an ambient relative humidity sensor.

4. The Ozone-Aided Combustion System (OACS) of claim 1 wherein said environmental sensor further comprises an ambient atmospheric pressure sensor.

5. The Ozone-Aided Combustion System (OACS) of claim 1 wherein said environmental sensor further comprises an ambient temperature sensor.

6. The Ozone-Aided Combustion System (OACS) of claim 1 wherein said control computer that compensates for ozone generation efficiency based on the ambient relative humidity of said internal combustion engine.

7. The Ozone-Aided Combustion System (OACS) of claim 1 wherein said control computer that compensates for ozone generation efficiency based on the ambient atmospheric pressure of said internal combustion engine.

8. The Ozone-Aided Combustion System (OACS) of claim 1 wherein said control computer that compensates for ozone generation efficiency based on the ambient temperature of said internal combustion engine.

9. An Ozone-Aided Combustion System (OACS) comprising:
Air dryer;
Ozone generator;
High voltage power supply;
Humidity/pressure/air temperature sensors;
Control computer; and
Display/system control unit;
wherein
said air dryer receives air from an air input/air filter to produce dried air;
said ozone generator takes said dried air to generate ozone for use in an internal combustion engine;
said high voltage power supply provides voltages necessary for proper operation of said ozone generator;
said humidity/pressure/air temperature sensors monitor the ambient conditions of said internal combustion engine;
said control computer modulates the operation of said air dryer and said high voltage power supply in response to input from said humidity/pressure/air temperature sensors and demand from said internal combustion engine; and
said display/system control unit permits configuration and monitoring of said computer control system that modulates the overall operation of said OACS.

10. The Ozone-Aided Combustion System (OACS) of claim 9 wherein said ozone generator comprises a corona discharge.

11. An Ozone-Aided Combustion System (OACS) of claim 10 wherein the Display/System is configured as a touch screen system with the indicators being part of the screen and the control buttons being touch sensitive parts of that touch screen display.

12. An Ozone-Aided Combustion System (OACS) of claim 11 wherein the pollution generated by the internal combustion engine will be reduced by the effect of the ozone during combustion.

13. An Ozone-Aided Combustion System (OACS) of claim 12 wherein the power output of the internal combustion engine will be increased due to the fact that during combustion with ozone addition, nitrous oxides are also formed and burned during the combustion cycle.

14. An Ozone-Aided Combustion System (OACS) comprising:
Air dryer;
Hydrolysis device having oxygen and hydrogen outputs;
Ozone generator;
High voltage power supply;
Humidity/pressure/air temperature sensors;
Control computer; and
Display/system control unit;
wherein
said air dryer receives air from an air input/air filter to produce dried air;
said ozone generator takes said dried air to generate ozone for use in an internal combustion engine;
said hydrolysis device takes water and converts it to oxygen for input to said ozone generator and hydrogen for input to said internal combustion engine;
said high voltage power supply provides voltages necessary for proper operation of said ozone generator;
said humidity/pressure/air temperature sensors monitor the ambient conditions of said internal combustion engine;
said control computer modulates the operation of said air dryer, said high voltage power supply, and said hydrolysis device in response to input from said humidity/pressure/air temperature sensors and demand from said internal combustion engine; and
said display/system control unit permits configuration and monitoring of said computer control system that modulates the overall operation of said OACS.

15. The Ozone-Aided Combustion System (OACS) of claim 14 wherein said ozone generator comprises a corona discharge.

16. An Ozone-Aided Combustion Method (OACM) comprising the steps of:
Receiving air intake from an air source;
Pre-processing said air intake to from one or more oxygen source(s);
Injecting said oxygen source(s) into an ozone generator;
Converting said oxygen source(s) to ozone in said ozone generator;
Transferring said ozone and/or additional fuel to an internal combustion engine;
Monitoring the environmental conditions associated with said internal combustion engine; and
Varying said air pre-processor and said ozone generator output using a control computer based on said environmental conditions by controlling said step (2) and said step (4) as required based on the requirements of said internal combustion engine.

17. The Ozone-Aided Combustion Method (OACM) of claim 16 wherein said ozone generator comprises a corona discharge.

18. The Ozone-Aided Combustion Method (OACM) of claim 16 wherein said environmental conditions are monitored with an environmental sensor further comprising an ambient relative humidity sensor.

19. The Ozone-Aided Combustion Method (OACM) of claim 16 wherein said environmental conditions are monitored with an environmental sensor further comprising an ambient atmospheric pressure sensor.

20. The Ozone-Aided Combustion Method (OACM) of claim 16 wherein said environmental conditions are monitored with an environmental sensor further comprising an ambient temperature sensor.

21. An Ozone-Aided Combustion Method (OACM) comprising the steps of:
Receiving air intake from an air input/air filter source;
Removing moisture from said air intake to form dried air;
Injecting said dried air into an ozone generator;
Converting said dried air to ozone in said ozone generator;
Transferring said ozone to an internal combustion engine;
Monitoring said humidity, pressure, and temperature conditions associated with said internal combustion engine;
Varying said air dryer and said ozone generator output using a control computer based on said humidity, pressure, and temperature conditions by controlling said step (2) and said step (4) as required based on the requirements of said internal combustion engine; and
Reporting the status of said air dryer and said ozone generator to a vehicle control computer.

22. The Ozone-Aided Combustion Method (OACM) of claim 21 wherein said ozone generator comprises a corona discharge.

23. An Ozone-Aided Combustion Method (OACM) comprising the steps of:
Receiving air intake from an air input/air filter source;
Removing moisture from said air intake to form dried air;
Hydrolyzing water into hydrogen and oxygen;
Injecting said hydrolyzed oxygen into an ozone generator;
Injecting said dried air into said ozone generator;
Converting said injected dried air and said injected oxygen to ozone in said ozone generator;
Injecting said hydrolyzed hydrogen into an internal combustion engine;
Transferring said ozone to said internal combustion engine;
Monitoring the humidity, pressure, and temperature conditions associated with said internal combustion engine;
Varying said air dryer, said ozone generator output, and hydrolyzer output using a control computer based on said humidity, pressure, and temperature conditions by controlling said step (2), said step (3), and said steps (4) as required based on the requirements of said internal combustion engine; and
Reporting the status of said air dryer, said ozone generator, and said hydrolyser to a vehicle control computer.

24. The Ozone-Aided Combustion Method (OACM) of claim 23 wherein said ozone generator comprises a corona discharge.
